(19) United States
(12) Patent Application Publication
(10) Pub. No.: US 2014/0283987 A1
(43) Pub. Date: Sep. 25, 2014

(54) METHOD AND APPARATUS TO APPLY A FILL MATERIAL TO A SUBSTRATE

(71) Applicant: Systems and Materials Research Corporation, Austin, TX (US)

(72) Inventors: Anjan CONTRACTOR, Austin, TX (US); Malcolm David PROUTY, Austin, TX (US); Jesse Baskin MCDANIEL, Austin, TX (US); Keris Allrich WARD, Austin, TX (US); Christopher M. PAVLOS, Austin, TX (US); Christopher Young INGHAM, Austin, TX (US)

(73) Assignee: Systems and Materials Research Corporation, Austin, TX (US)

(21) Appl. No.: 14/220,120

(22) Filed: Mar. 19, 2014

Related U.S. Application Data
(60) Provisional application No. 61/803,441, filed on Mar. 19, 2013.

(51) Int. Cl. B32B 37/00

(52) U.S. Cl. CPC B32B 37/0046; B32B 2307/738; B32B 2310/0843; B32B 2311/30; B32B 2375/00; B32B 2605/18
USPC 156/272.8; 156/367

(57) ABSTRACT

A method for rapidly adhering thermoplastic polyurethane (TPU) material to a void in a metallic surface, the method comprising placing a solid volume of a TPU over metallic surface; directing a laser toward the TPU; applying pressure on the TPU; and irradiating the TPU material until the material melts and adheres to the metallic surface. Some embodiments make use of a hand-held near-infrared radiation laser tool to irradiate the TPU material, the laser tool comprising a laser optics and fiber; a housing for holding said laser optics and fiber and maintaining a desired distance and orientation of the laser relative to the fastener to be filled; electronics for controlling said laser; a collimator; a beam expander; a laser shield; and a conformal dome or a flat pressure head for holding a solid portion of a filler material in place while the beam is used to melt the material and for applying pressure to the melted filler material.

### CROSS-REFERENCE TO RELATED APPLICATION

The present application claims priority from U.S. Provisional Patent Application No. 61/803,441 filed Mar. 19, 2014, entitled “RAPID INTELLIGENT FASTENER FILL SYSTEM,” naming Anjan CONTRACTOR et al., which application is incorporated by reference herein in its entirety.

### FIELD OF THE DISCLOSURE

The present invention relates in general to fillers for use with fasteners used on a structure's surface, and in particular the application of a filler used to fill the void over a countersunk fastener on the surface of an aircraft.

### BACKGROUND

A typical manner of fastening one structural component to another is to employ fasteners, which are countersunk so that the head of the fastener is below the surface of the component being joined. In many aerospace applications, particularly airplane manufacture, whenever a rivet or other fastener is used on an exterior surface, the fastener is typically countersunk and a filler applied to fill the void over the countersunk fastener. The filler is used to fill the void and then any excess filler material removed so that the filler is flush with the surrounding aircraft outer mold line (OML).

The fastener fill material can be a polyester-based polyurethane thermoplastic (TPU) or other appropriate polymer fill material. The fastener filler material can be provided as a large sheet from which is punched a large number of hot melt filler “dots” having a size roughly equal to the size of the void and stamped from sheets of the filler material (for example, from 0.635 mm thick sheets of the polyester-based TPU material MERQUINSA PEARLCOAT® 125K A typical fastener fill installation process involves the installer applying a filler dot over the void above the countersunk fastener. Heat and pressure are then applied to the filler dot using a heated quarter-round platen, thereby causing the filler dot to melt and completely fill the void. Any excess filler material is then removed, usually with a skiving blade, so that the filled fastener void is flush with the OML of the aircraft.

Unfortunately, this process typically requires as much as two minutes per fastener. Because a large aircraft can have thousands or even tens of thousands of countersunk fasteners on the outside surface of the aircraft, this adds up to a considerable expenditure of time and effort. At full production rates, current fastener fill processes becomes a severe bottleneck in the aircraft manufacturing flow. To keep up with demand and avoid a bottleneck in the manufacturing process, fastener fill installation requires a fastener-to-fastener fill time of 30 seconds or less.

What is needed therefore is an improved process for applying filler to countersunk fasteners.

### SUMMARY OF THE INVENTION

The present disclosure is generally is directed to applying a fill material to the void over a countersunk fastener so that the void is completely filled.

In one aspect, a method for rapidly adhering filled thermoplastic polyurethane (TPU) material over a metallic surface is provided, the method comprising placing a solid volume of a TPU over metallic surface; directing a laser toward said TPU; applying pressure on TPU; and irradiating said TPU material until the material melts and adheres to the metallic surface. In another aspect, the method comprises directing a laser toward said polymer material using a near-infrared radiation laser tool comprising a laser optics and fiber; a housing for holding said laser optics and fiber and maintaining a desired distance and orientation of the laser relative to the fastener to be filled; electronics for controlling said laser; a collimator; a beam expander; and a laser shield.

In another aspect, a laser apparatus for rapid fastener fill is provided, the apparatus comprising laser optics including a fiber-optical cable for producing a beam of radiation; a housing for holding said laser optics and fiber-optical cable; electronics for controlling said beam; a collimator; a beam expander; a laser shield; and a conformal dome or a flat pressure head for holding a solid portion of a filler material in place while the beam is directed at the filler material to melt the material and applying pressure to the melted filler material by pressing the filler material between the conformal dome or a flat pressure head and a substrate surface.

The foregoing has outlined rather broadly the features and technical advantages of the present invention in order that the detailed description of the invention that follows may be better understood. Additional features and advantages of the invention will be described hereinafter. It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present disclosure may be better understood, and its numerous features and advantages made apparent to those skilled in the art by referencing the accompanying drawings.

FIGS. 1A and 1B illustrate schematically the prior art use of a countersunk fastener to join structural components.

FIGS. 2A and 2B illustrate a prior art installation method using a hand-held heated quarter-round platen installation tool.

FIG. 3 shows a graph of temperature vs. time using different power settings of a YLR laser.

FIG. 4 shows a graph of temperature vs. time using different power settings of a DLR laser.

FIG. 5 shows a compression head for use in preferred embodiments of the present invention.

FIG. 6 shows a PEEK skiving blade being used to remove excess TPU material from a test location.

FIG. 7 shows a photograph of the TPU fill test panel (with a plurality of filled holes), an exemplary oscillation tool, and a variety of polymer skiving blades.

FIG. 8 shows Pareto charts of an evaluation of skiving results for a variety of blades, angles, and vibrations.

FIGS. 9A and 9B show an embodiment of a hand-held rapid fill tool according to the present invention.

FIG. 10 shows a graph of temperature vs. time for nine different experimental samples exposed with a two-step laser power program.

FIG. 11 shows a graph of temperature vs. time at different laser ramp rates.

FIG. 12 shows a graph of temperature vs. time using a determined optimal power cycle for the laser.

FIG. 13 shows the energy per unit volume for various process recipes.

FIG. 14 a graph of temperature vs. time for an optimized process recipe.

FIG. 15 is a table showing dimensions of three different TPU dots of the same type and size.

FIG. 16 shows the results of the calculation of optimal energy range for the type of TPU dot measured in FIG. 15.

FIG. 17 is a table showing calculated total energy values for the optimal process recipe for a given TPU dot type calculated from a decreasing gradient of power and a total time desired.

FIG. 18 is a table showing calculated laser melt recipes for different TPU dot types.

FIG. 19 is a table comparing adhesion values obtained by an embodiment of the present invention to adhesion values using a prior art method.

FIG. 20 is a flow chart showing the steps in operating a rapid filler installation tool according to an embodiment of the present invention.

FIG. 21 shows a conformal dome used to apply uniform pressure on the TPU dot placed on over the fastener according to an embodiment.

The accompanying drawings are not intended to be drawn to scale. In the drawings, each identical or nearly identical component that is illustrated in various figures is represented by a like numeral. For purposes of clarity, not every component may be labeled in every drawing.

### DETAILED DESCRIPTION OF PREFERRED EMBODIMENTS

This disclosure, in general, relates to rapid fill system and in particular to an apparatus and method to rapidly install a polymer fill material over an installed primed fastener head so that the fill is flush with the surrounding aircraft outer mold line (OML).

For certain types of aircraft manufacture, it is desirable that each fastener head in the outer mold line be covered with a fastener fill material, such as a filler formed from a polymer material such as a polyester-based thermoplastic polyurethane (TPU), prior to application of outer mold line primer and final finish coatings. For some aircraft, this process must be applied to all fastener heads in the outer mold line. This is currently a time-consuming, labor-intensive operation that results in a high potential for variations in installation quality from fastener to fastener. Embodiments of the present invention provide an automated handheld tool and method of installation that allows fastener fill material to be applied more rapidly, preferably in less than 30 seconds per fastener, and more uniformly. As compared to an aircraft with approximately 40,000 outer mold line fasteners filled at current fastener fill installation times of approximately 2 minutes per fastener, embodiments of the present invention provide a potential savings of 1,000 hours per aircraft.

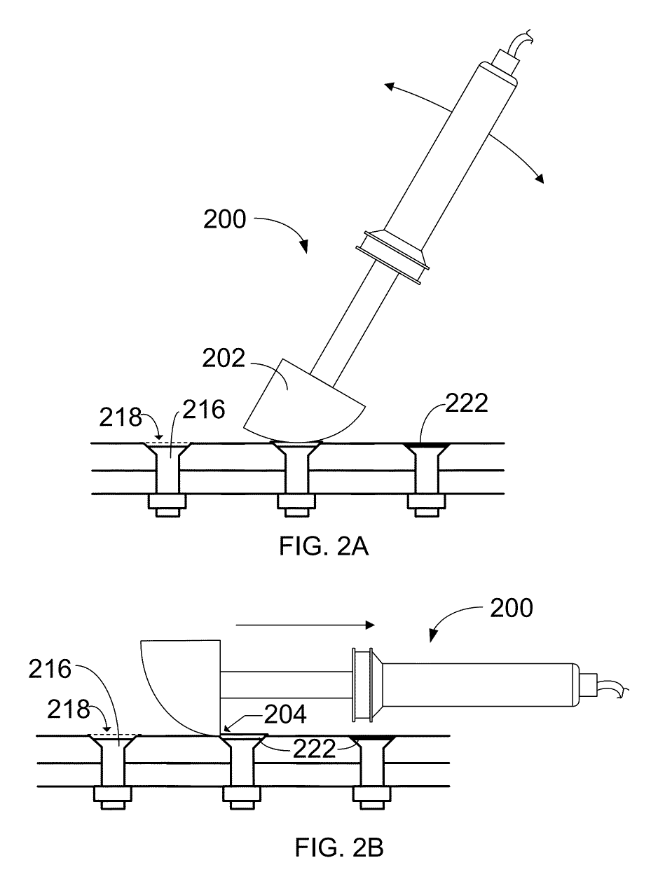

FIGS. 2A and 2B illustrate a prior art installation method using a hand-held heated quarter-round platen installation tool 200. A typical prior art fastener fill installation process involves the installer applying a filler dot 222 over the void 218 above a countersunk fastener 216. As shown in FIG. 2A, heat and pressure are then applied to the filler dot using a heated quarter-round platen 202, thereby causing the filler dot to melt and completely fill the void. Any excess filler material is then removed, as illustrated in FIG. 2B, usually with a skiving blade 204, so that the filled fastener void is flush with the OML of the aircraft (FIG. 2). There are many thousands of fasteners on a typical aircraft that require this treatment. The current process to install the filler on an already surface prepared fastener is performed entirely by hand and takes approximately 30 seconds to as much as two minutes per fastener. Considering the large numbers of fasteners in a typical aircraft, this prior art process is undesirably expensive and time-consuming.

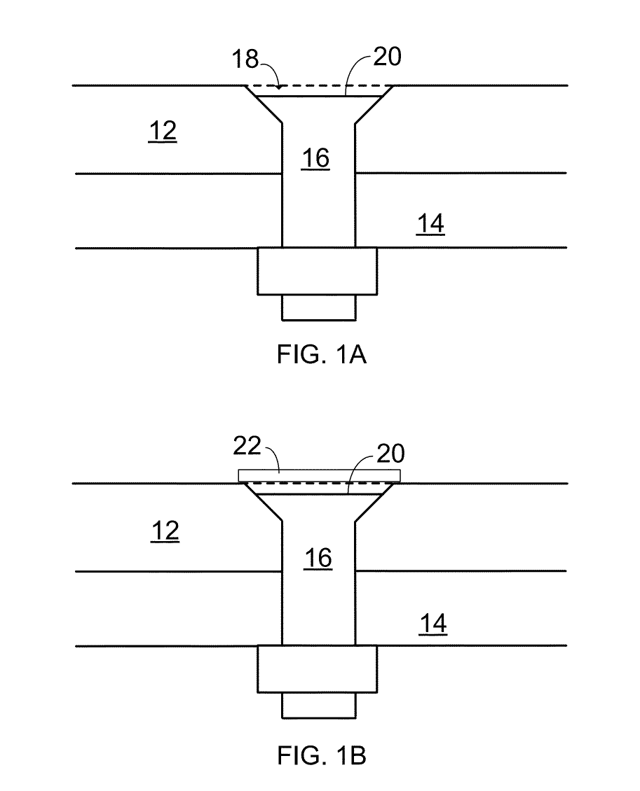

FIG. 1 illustrates schematically the prior art use of a countersunk fastener to join structural components. In FIG. 1, structural component 12, such as the outer body of an aircraft, is attached to an inner structural component 14 via fasteners 16. Once the fasteners are properly tightened, void 18 will be present above the uppermost surface of fastener 16. It is desirable to fill this void and to make the surface of the fill match the surface of the structural component as smoothly as possible.

The current prior art process for filling these types of countersink voids suffers from a number of shortcomings. The process must be done almost entirely by hand and is thus expensive and time-consuming. Also, a thorough melt of the TPU material is critical to ensuring adhesion of the TPU material to the fastener head, however, the current process does not provide the installer with any indication of installation quality other than feel. Poor adhesion can result in fastener fill materials detaching due to thermal/pressure cycling. Incomplete fill can leave air pockets that can create pressure gradients at high altitude. Non-flush fastener-fill materials above the OML may affect aircraft aerodynamics.

Preferred embodiments of an improved method and apparatus for applying a filler to countersunk fasteners should thus be able to at least partially correct some of the deficiencies of the prior art. Preferred embodiments should be able to at minimum replace manual prior art installation described above with an automated or semi-automated process. Preferred embodiments should also be able to consistently apply filler with a fastener-to-fastener time of 30 seconds or less. Further, preferred embodiments should consistently and uniformly melt the TPU material to ensure adequate adhesion of the filler material without any air pockets within the fill. Further, preferred embodiments should allow any excess fill material to be quickly and uniformly removed to produce a smooth OML.

An installation tool according to embodiments of the invention should be able to handle a wide range of TPU dot types and size, in order to accommodate many different fastener and countersink sizes. TPU dots have various configurations depending on the specific needs. For example, as shown in FIG. 1, dots are intended to be placed over countersunk voids. The size and configuration of the specific fastener may determine the configuration of the TPU dot. Particular embodiments should also be capable of being used over a wide variety of surfaces (including flat, simple curvature, and complex curvature surfaces) and used in any desired orientation (including horizontal, inverted, or vertical).

Some embodiments of an apparatus for applying the filler material should also be as short as possible, preferably less than 381 mm (15 inches) in length and should weigh less than 1134 gm (2.5 lb) for ease of use, because much of the installation process will take place in confined spaces or with an operator reaching overhead. Preferably the apparatus will also be easy to position over a TPU dot for installation. Embodiments that satisfy each of these general characteristics are described in detail below.

According to some embodiments of the present invention, use of an energy radiation source—such as a microwave energy source, infrared energy source, a near-infrared (NIR) energy source, an induction heater, or a laser—for uniform heating of the TPU filler material. The melted filler material is preferably forced into the countersink cavity by way of a conformal dome that applies pressure to the melted fill material uniformly, even on curved surfaces.

Peel tests were also conducted to check the bonding strength of the TPU dot material with carbon epoxy. The standard peel test method ASTM-D 3166 was followed. The test is used for fatigue properties of adhesives using plastic adherents. In this test, two plates of known thickness are used as adherents. Adhesive or bonding material is sandwiched between two plates. The thickness of the bonding material is maintained uniform. The test method covers the measurement of fatigue strength in shear by tension loading

The two plates were installed on Instron tensile test machine load cell via clamps. Instron strain rate was set low to provide relaxation to the bonding material. The force data was collected from the load cell into a computer and recorded real time.

As described above, a method of applying heat to the TPU material should consistently and uniformly melt the TPU material to ensure adequate adhesion of the filler material without any air pockets within the fill. Applicants have determined that a variety of methods could be used to accomplish this melting step, although several of these methods suffer from disadvantages that would make their use less than optimal under most circumstances.

### Microwave Melting

In some embodiments, microwave-based melting can be used to melt the TPU material by microwave radiation coupled into the microwave cavity through a dielectric material would heat the underlying TPU material providing uniform melting. A preferred microwave system consists of a microwave cavity coupled to the aircraft substrate through a conductive boot. Preferably, a plunger residing inside the microwave chamber is used to press against the melted TPU dot to force TPU material into the fastener cavity crevices. It is preferable that the dielectric constants of the plunger material and the TPU material match as closely as possible to provide improved microwave energy transfer efficiency. For example, strontium titanate, with a dielectric constant of 255, could be used as a plunger material to match the dielectric constant of the TPU material.

Modeling performed by the Applicants determined that a microwave frequency of about 750 MHz would be optimal for melting the 0.64 mm thick TPU dots. In practice, however, it has been determined much higher power levels are required. Applicants theorized that the countersunk fastener itself will act as a heat sink, transferring microwave-induced heating away from the TPU material before it reaches melt/flow temperature. This heat sink effect can be overcome with greatly increased microwave power levels. Of course, equipment size and cost, as well as operator safety, becomes an issue in using a microwave system capable of producing sufficiently high power levels to overcome the heat sink effect and adequately melt the TPU material.

### Induction Heating

In some embodiments of the present invention, induction heating can be employed. Induction heating is the process of heating an electrically conducting object by electromagnetic induction, where eddy currents are generated within the metal and resistance leads to joule heating of the metal. The induction heater provides high frequency alternating current to an electromagnet. Magnetic materials improve the induction heat process due to hysteresis. Heat is generated by magnetic hysteresis losses in the material with high permeability, and as a result materials with high permeability are easier to heat via induction heating. Typically, induction heaters are used to heat bulk metallic materials such as iron rods, metallic bowls, etc., but can be used in embodiments of the present invention.

The Applicants have discovered that induction heating rapidly heats metallic objects within a wire wound core to extremely high temperatures by coupling a magnetic field to a metallic object and inducing eddy currents, which in turn causes resistive heating. Several metallic materials were heated with an induction heater to 149° C. (300° F., melting temperature of TPU material) to determine their respective heating rates. Carbon steel had the fastest heating rate, reaching 149° C. (300° F.) in 5 seconds. It was also found, however, that inductive heating is prone to result in much higher temperatures, which would damage the TPU material. Temperature profile of initial heating of carbon steel showed regulated temperature of 149±6° C. (300±11° F.). In this temperature profile, the carbon steel was heated rapidly at full power to 143° C. (289° F.). After crossing the 143° C. (289° F.) threshold, the duty cycle was lowered to 30 percent to reduce the heating rate. When the temperature of the carbon steel passed the 155° C. (311° F.) threshold, the induction heater was turned off to allow the carbon steel to cool. The temperature of the carbon steel was maintained at 149° C.±6° C. (300° F.±11° F.) using this variable duty cycle technique. Inductive heating also tends to generate a large amount of heat in order to melt the TPU and thus would require increased heat shielding or other forms of extensive heat removal to keep a hand-held tool cool to the touch and safe for the operator.

### Infra-Red Melting

In some embodiments, the TPU filler material can be heated by way of infrared energy. For example, infrared energy could be supplied to the TPU material by using an incandescent IR system (for example SpotIR® 4150 of Research, Inc.). An infrared energy source would preferably be coupled with a plunger that is used to press against the melted TPU dot to force TPU material into the fastener cavity crevices. A preferred plunger material would transmit IR radiation to allow the underlying TPU material to fully absorb the energy, which would improve melting of the TPU material. Quartz is an example of a material that readily transmits IR radiation.

While IR radiation has been found to readily heat the TPU material to its melting point, Applicants determined a number of disadvantages of using an IR heating system with embodiments of the present invention, First, plungers formed of materials such as quartz, while adequately transmitting IR radiation, tend to undesirably stick to the melted TPU material. Further, Applicants have discovered that IR radiation tends to cause some undesirable charring when the TPU material is heated rapidly. This results from the IR heating mechanism, which heats the TPU dot surface via radiation followed by bulk heating of the remained of the TPU through conduction. When the IR energy is sufficient to rapidly heat the bulk of the TPU, the surface of the TPU dot is overheated and damaged. Applicants have discovered that for many polyester-based polyurethane thermoplastic materials this charring effect is especially problematic at energy wavelengths above about 2,000 nm. As a result, a notch filter is preferably used to restrict energy output to the near-infrared spectrum (800 nm to 2,000 nm).

Heating using energy in the near-infrared (NIR) range is more desirable because energy in this range actually passes through most non-metallic materials, including quartz and Teflon®, among others, because of low molecular absorptivity by the molecules of these material. However, NIR can effectively resonate metals and thus more effectively increase the temperature of such materials. The TPU dots will actually heat from the inside out, which causes the TPU material to melt without the surface charring caused by higher IR frequency radiation.

In a preferred embodiment of a near-infrared heating unit for use in a rapid fill system according to the present invention, near-infrared energy can be generated from a 300 W NIR emitter and focused through an optical notch filter into a light guide connector using a reflector. The notch filter will preferably pass only NIR wavelengths absorbed by the fastener fill material, converting unused energy to heat. This excess heat can be removed with a large heat sink and forced-air cooling. A liquid light guide (LLG) can be used to transfer NIR energy from the source emitter to the focusing optics of the rapid fill system. A preferred LLG uses liquid crystals that can transmit radiation at a wavelength of up to 2000 nm at 15 to 80 percent transmittance. One end of the LLG is preferably connected to the NIR source and the other to a compression head, described in greater detail below, which is used to maintain uniform pressure on the TPU fill material while transmitting the NIR energy to the TPU material without a major loss of NIR intensity.

One disadvantage of this type of NIR system, however, is that the higher wavelengths of NIR (1100 to 2000 nm) are detrimental to conventional liquid light guides. Unfortunately, those higher wavelengths are the wavelengths that most effectively heat the TPU fill material. As a result, such a NIR system requires a balance between heating times and damage to the LLG components.

### NIR Laser Melting

In some preferred embodiments, the near-infrared energy can be supplied using an infrared laser source, rather that the incandescent NIR bulb of the previous embodiment. An advantage of using a laser as an NIR energy source is that the beam coherence allows it to be readily transmitted through a fiberglass light guide for great distances (more than 100 feet) without significant losses. Examples of a laser source suitable for use with embodiments of the present invention are the diode laser (DLR) and yttrium based laser (YLR) commercially available from IPG Photonics that can emit up to 100 W of collimated radiation at 975 nm and 1070 nm wavelength. A suitable laser system is preferably coupled to a fiber optics waveguide.

Fiber-optic material is a flexible, transparent fiber made of a fused silica to transport light at significantly farther distance. Fiber optic light guide made by fused silica is usually surrounded by a transparent cladding material and wrapped by a protective material outside. Cladding material is made of lower refractive index such that the light is kept within the core by internal reflection. The fiber-optic light guide connected to YLR and DLR laser varies from 50 μm to 200 μm in diameter. This light guide cable can extend more than 30 meters in length with very minimal loss within the travel path. One end of the light guide is connected to the laser source and the other end is usually connected to an optical train to expand the beam diameter to the required size. Optical train is comprised of a collimator and Galilei or Kepler type beam expander. The beam expander can vary beam diameter from 5 mm to 25 mm.

Applicants conducted an evaluation of the temperature profile of the TPU dot material for laser system. The laser system used for the evaluation was YLR, a yttrium based system, and DLR, a diode system. A narrow hole was drilled through the fastener and a thermocouple was installed at the backside of the fastener top surface. The thermocouple wire was connected to a microprocessor, which converted analog signal to digital. The microprocessor collected signal from a thermocouple every 0.1 second. The microprocessor was connected to a laptop computer via USB connection, which was programmed to start and stop data collection from a microprocessor and save data file into a computer. The data collection started just before the laser was triggered to provide energy onto the TPU dot material and stopped right after laser was turned off. The YLR type laser provided uncollimated light on to the TPU dot and DLR laser provided collimated light on the surface.

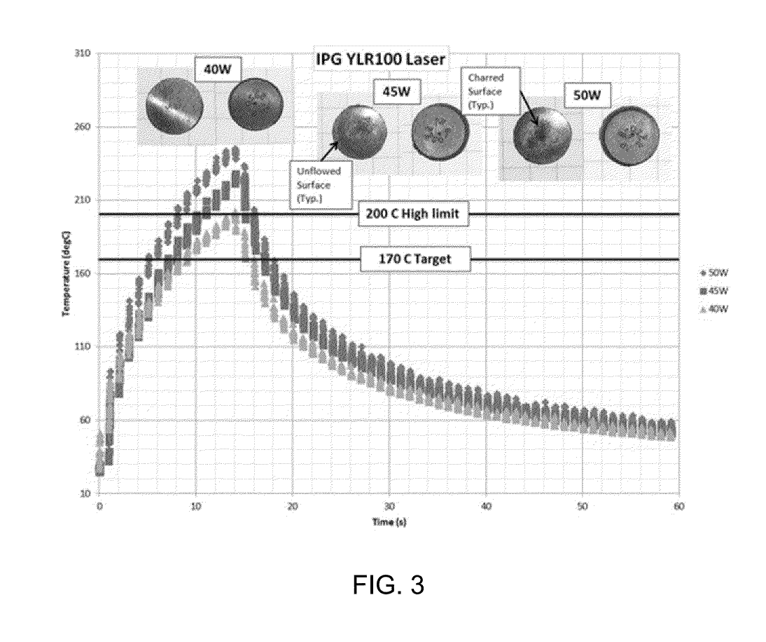

The YLR laser provided 1070 nm wavelength continuously at 100 W maximum capacity. The temperature results obtained by YLR laser system are shown in FIG. 3. The YLR laser provided continuous power for up to 15 seconds on top surface of the TPU dot. The laser beam profile was Gaussian for this type of laser. A secondary low power pointer laser was used to align beam with the TPU dot position.

The distance from the edge of the collimator to the TPU dot surface was set at 90 mm. The power settings of the laser were set to 40 W, 45 W and 50 W respectively for 12 mm head diameter fasteners. Temperature recording started just before the laser triggered on and stopped when the temperature of the TPU dot reached approximately 70° C. (158° F.). The target temperature was 170° C. (338° F.) with the high limit of 200° C. (392° F.). These are the temperatures when TPU dot material changes phase and starts charring beyond the limit. As seen from the chart, the temperature rose fairly quickly to 170° C. (338° F.) within 5 seconds at 50 W setting, within 6 seconds at 45 W setting, and within 8 seconds at 40 W setting. At the end of 15 seconds of heating, the temperature for 50 W was approximately 240° C. (464° F.), for 45 W it was approximately 220° C. (428° F.), and for 40 W it was approximately 200° C. (392° F.). The temperature drop was fairly slow compared to the rise. At the end of 60 s, 50 W power was at 60° C. (140° F.), 45 W power was at 50° C. (122° F.), and 40 W power was at 45° C. (113° F.). The dot surface profiles are shown on top of the curves in FIG. 3.

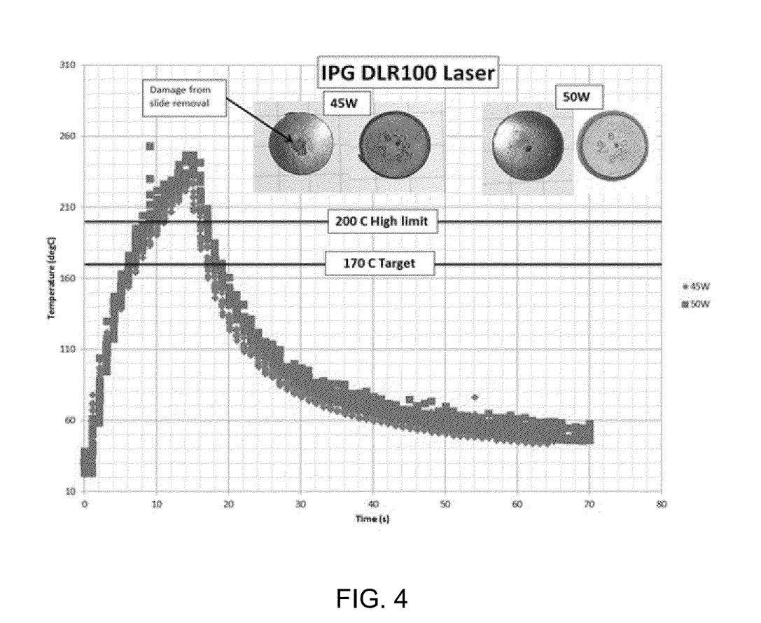

The temperature results obtained by the DLR type laser system are shown in FIG. 4. The DLR laser was fixed at 975 nm wavelength and 100 W maximum power capacity. The laser provided continuous power for up to 15 seconds on top surface of the TPU dot. The laser beam profile was collimated for this configuration. The power setting of laser was set at 45 W and 50 W respectively for 12 mm head diameter fastener. The temperature was recorded just before the laser triggered on and stopped when the temperature of the TPU dot reached approximately 70° C. (158° F.). The target temperature was 170° C. (338° F.) with the high limit of 200° C. (392° F.). The temperature rose fairly quickly to 170° C. (338° F.) within 5 seconds at 50 W setting, and within 6 seconds at 45 W setting. At the end of 15 seconds, the temperature for 50 W was approximately 240° C. (464° F.); for 45 W it was approximately 220° C. (428° F.). The temperature drop was fairly slow compared to the rise. At the end of 60 seconds, 50 W power was at 58° C. (136° F.), and 45 W power was at 55° C. (131° F.). The dot surface profiles are shown on top of the curves in FIG. 4.

With the YLR type laser, TPU dot material absorbed a higher level of energy from incident NIR light in comparison to DLR type laser. This is shown in the top images in FIG. 3 and FIG. 4. From the TPU dot image, it can be seen that 50 W power applied by YLR laser for 15 seconds charred the center of the dot, while the DLR laser operated at the same temperature did not char the surface.

Charring in this case appears to be related to higher energy absorption. The TPU dot material is more transparent to the DLR laser light due to lower wavelength light, which does not burn the polymer matrix of the dot. A similar conclusion can be drawn at 45 W power level. The pictures of post-melt at 45 W power shows charring for YLR laser but at the same power setting, DLR laser shows no charring. DLR laser is thus more favorable in comparison to YLR laser (FIG. 3 and FIG. 4).

### Compression Head

Preferred embodiments of the present invention also make use of a compression head to center a TPU fastener fill dot under the compression head prior to fastener fill installation, and allow maximum transmission of NIR energy to quickly heat the underlying TPU fastener fill material and provide enough compression to completely flow the fastener fill material, filling the fastener cavity, during fastener fill installation.

It is desirable that the compression head use an optically transparent window that allows NIR radiation to pass with little to no energy loss. The typical wavelength range for NIR radiation used in embodiments of the present invention is from 400-2,000 nm. Suitable materials for use as a compression head over this wavelength range include NIR fused silica, sapphire, quartz, and UV fused silica among others. Quartz coated with a thin layer of Teflon (less than 0.05 mm) was used by Applicants for initial experimentation.

A Teflon coating can be used with any suitable material to prevent the TPU fastener fill material from sticking to the compression head window while installing the TPU fill material. Preferably, the rapid fill system comprises tooling developed around the window including brackets to hold an NIR temperature sensor to monitor the fastener fill temperature during melting and provide closed-loop feedback to the NIR source, along with a CCD camera to visually center the compression head over a fastener cavity and monitor the material as it is installed.

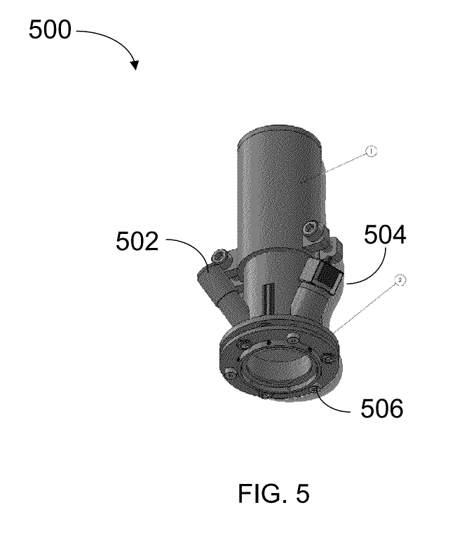

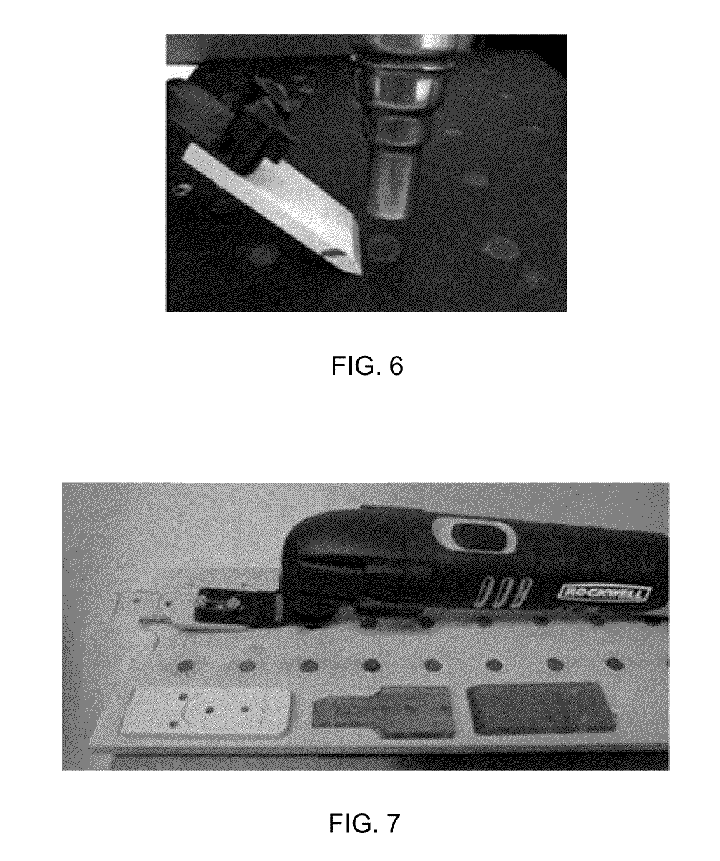

FIG. 5 shows one embodiment of a compression head 500 for use in preferred embodiments of the present invention. The compression head was designed to be fully adjustable to optimize the melt times of the thermoplastic fastener fill material. A preferred compression head can include
1) An adjustable LLG light guide adapter to adjust the NIR radiation height above the thermoplastic fastener fill material from 30-60 mm;
2) NIR temperature sensor port (502) to monitor the temperature of the fastener fill material as it is heated to provide closed-loop feedback to the remote NIR system;
3) CCD camera port (504) to visually align the tool over the center of the fastener head while the user is engaging the tool;
4) Pressure sensors (506) to monitor the amount of pressure applied during each fastener fill dot installation;
5) Temperature sensors to monitor the head buildup throughout the compression head during fastener fill dot installation; and
6) Quartz compression window to apply pressure to the TPU fastener fill material while being irradiated with NIR energy.

Suitable compression heads for use according to embodiments of the present invention can make use of a number of techniques to center the TPU dots under the compression head, including using multiple flat TEFLON-coated quartz disks to match varying TPU dot diameters, a single staggered TEFLON-coated quarts disk that could hold several TPU dot diameters using a single compression head; or a single free Teflon sheet formed into an inverted cone using vacuum to hold several TPU dot diameters, and applying compression using a quartz plate on the back-side of the TEFLON sheet.

### Skiving Tool

Installation of a TPU dot on the countersink hole fills the gap effectively; however it leaves a non-flush surface with the aircraft skin. This extra TPU dot material needs to skive off to leave a flush surface. Prior art installation methods use a hot iron to skive the protruded TPU material. This hot iron is highly inconvenient and takes greater than 30 seconds to skive off the material.

In preferred embodiments of the present invention, thermoplastic skiving blades are used to remove excess fill material. Such blades can be formed, for example, from thermoplastics with glass transition temperatures that are above the melting point of the TPU fill material. For example, blades can be formed from PEI, an amber colored thermoplastic with glass transition temperature of 216° C. (421° F.) or from PEEK, an opaque material with glass transition temperature of 143° C. (289° F.). The retention of mechanical properties at high temperatures for PEEK and PEI make them ideal candidates for skiving. Both materials show good mechanical properties, high impact strength, and a high degree of chemical resistance. Both materials are widely used in medical, chemical, and aerospace industries.

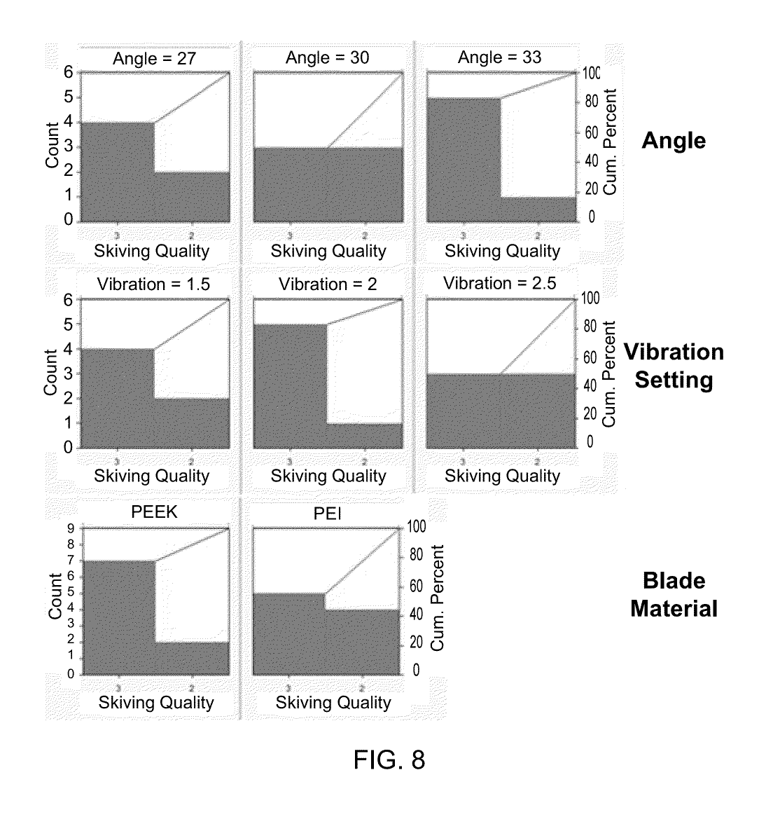

These thermoplastic skiving blades are preferably used with some type of oscillating tool that vibrates the blade, allowing it to cut through the TPU material quickly and effectively. Several different blade designs were evaluated including double bevel and single bevel. FIG. 8 shows Pareto charts of an evaluation of skiving results for a variety of blades, angles, and vibrations, with skiving quality evaluated according to the following table.

TABLE 1
Skive Quality

| | |
|---|---|
| 1 | Under Skived - Blade Issues |
| 2 | Slightly Under Skived |
| 3 | Good Skive |
| 4 | Slightly Over Skived |
| 5 | Over Skived |

After skiving with different bevel types, it was found that the fastest, cleanest skive resulted from a single bevel design. The skiving process, including acetone wipe, was optimized to take 12 seconds. According to particular embodiments, combined with tool alignment and a dot melt recipe of 15 seconds or less, total install times including skiving are less than 30 seconds. For the smaller dot sizes, it was found that a narrow blade just larger than the dot size was ideal for optimal skive without OML surface primer damage. Larger dot sizes skived best with a larger blade that fully covered the dot material and was just greater than the dot diameter. Tailoring the size of the blade to each dot type minimized OML surface primer damage, and resulted in a flush dot surface with the primed panel.

In order to evaluate skiving blade material, vibration level, and angle of operation, Applicants performed a design of experiment (DOE—FIG. 8) approach to evaluate overall skiving quality. In this approach, three vibration levels, three angles, and two blade materials were evaluated with different skiving trials. The skiving was performed on a small dot size with a narrow blade to minimize primer damage. The skiving angles were chosen based on observation of the natural angle used in previous skiving trials. The observed angle of the user was 30 degrees, and angles were chosen around this level, namely 27 and 33 degrees. To fix the skiving angle, a small block cut to the desired angle was fixed to the back of the skiving blade. This ensured a planar skive across the dot surface with the specified angle was used in each trial. The best combination of angle, vibrations, and blade were 33 degrees, vibration set at 2, and PEEK blade. Even though a skiving quality scale from 1 to 5 was used, only two quality levels were observed during the trials. Some results were under-skived, indicating a level 2 quality, but most results showed a good skive at level 3 quality.

### Alignment System

Preferred embodiments of the present invention also make use of an alignment system, such as a sight glass and centering laser. Applicants have determined that even inexperienced users were able to show alignment times of less than 3.6 sec and accuracies of less than 0.7 mm when aligning a mock rapid fill system over installed fasteners in both upright and inverted orientations. An improved alignment system along with end-user training can be expected to further reduce alignment times and improve centering accuracies.

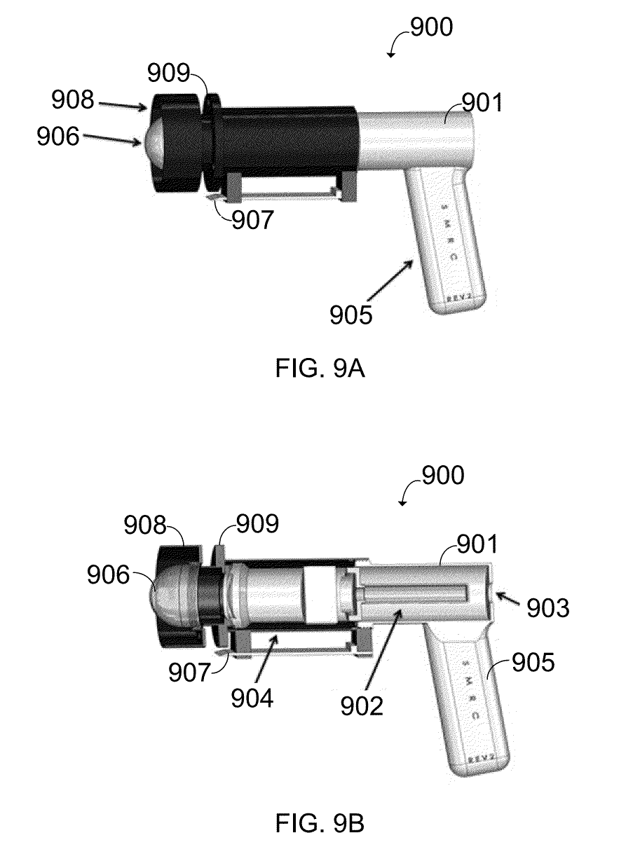

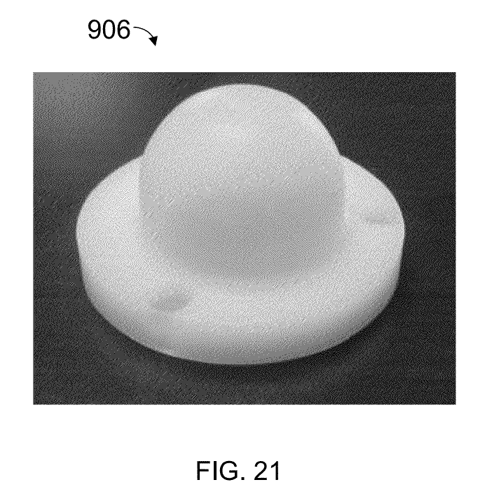

FIG. 9A shows an embodiment of a hand-held tool 900 incorporating many of the characteristics and features described above. FIG. 9B shows the hand-held tool of FIG. 9A with a portion of body 901 and NIR shield 908 cut away to show interior features. Tool 900 makes use of an NIR laser to melt the TPU filler material, and incorporates laser optics such as a collimator 902 and beam expander 904, within the body 901. The NIR laser energy is supplied through a fiber-optic cable (not shown) attached to the body of tool 900 through a fiber-optic cable input 903. Tool electronics can be housed within handle 905. The hand-held tool 900 is preferably less than 381 mm (15 inch) in total length, less than 1134 gm (2.5 lb) weight, ergonomically friendly, highly visible and compatible with various dot sizes. Referring also to FIG. 21, the embodiment shown in FIGS. 9A-9B uses a conformal dome 906 to apply uniform pressure on the TPU dot placed on the fastener countersink. NIR shield 908 surrounds the conformal dome stops radial scattering of the laser. NIR shield 908 is made of a viscoelastic laser opaque material. A low power, red color secondary centering laser can be used to help users to align conformal dome on the TPU dot.

When the conformal dome is centered over the TPU dot, the tool is pushed forward to apply pressure on the TPU dot. Pushing the tool toward the surface brings flange 909 into contact with the rear surface of NIR shield 908. In some embodiments, there are one or more pins or electrical contacts on the flange such that the laser will not trigger unless the electrical contact is made. This ensures that the laser can only be triggered when the tool is pressed down onto a solid surface. In a particular embodiment, three contact sensor pins are mounted through the flange. The pins close an electrical connection when pressed against the NIR shield. The user must keep three pins fully depressed and also pull a trigger or activate a firing switch in order to keep laser on.

Once the laser is activated, the process should take anywhere from 4 to 7 seconds to completely melt the TPU dot inside the fastener cavity. In some embodiments, a user can then lift the tool away from the installed dot and push a second button by the handle to extend a skiving blade. A user can skive the extra material to flush the surface with OML.

In preferred embodiments, a computer program can be used to communicate with and control the laser unit for effective external control of the laser's power emission. The software is preferably able to communicate with the laser unit via simple code language allowing users to vary power instantaneously. This contributes to the ability to achieve optimal melt quality and strong adhesion to the fastener surface with high repeatability. In some embodiments, once properly positioned over a fastener, the tool can operate automatically to place a TPU dot over a sample, thoroughly melt the TPU dot, and apply sufficient pressure to completely fill the void over the countersunk fastener. In some embodiments, the tool can be placed over the correct location, such as a countersunk fastener, by hand. In other embodiments, the tool can be loaded into a robot arm which can automatically locate the next countersunk fastener to be filled and then properly position the two, before the rest of the process also proceeds automatically.

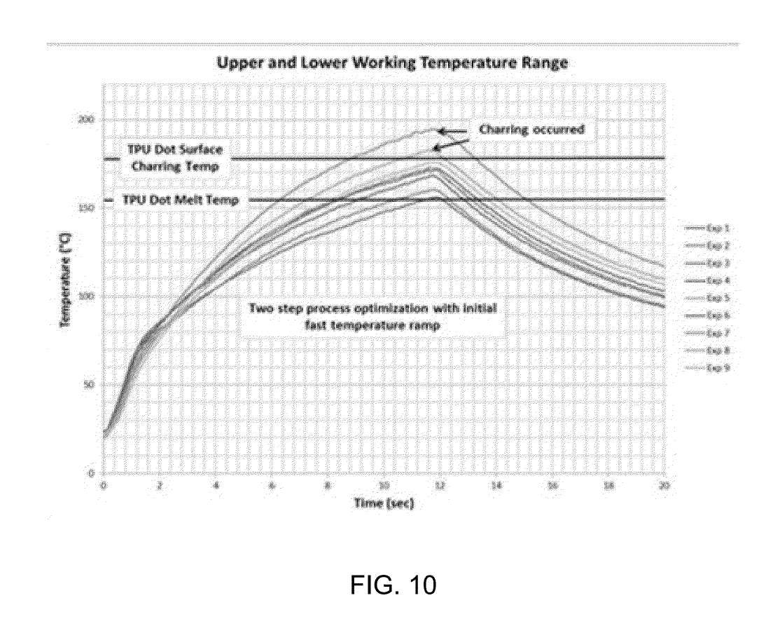

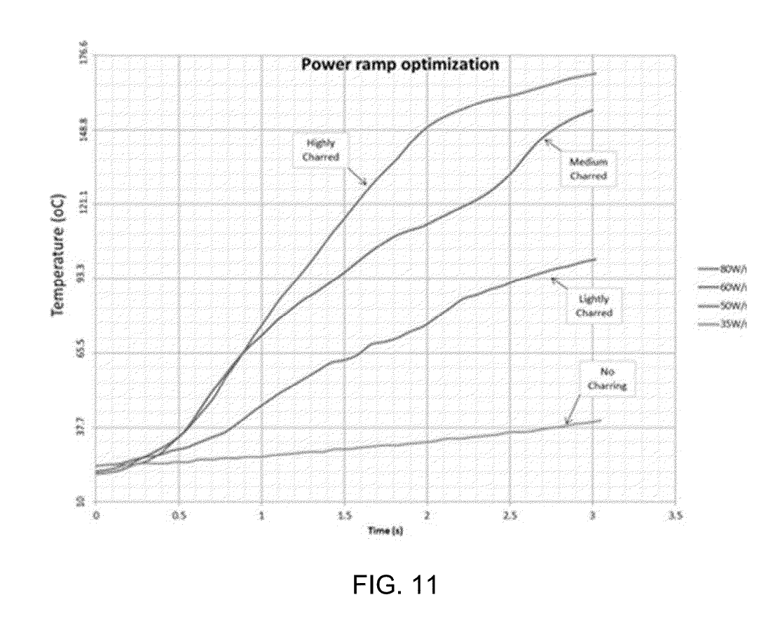

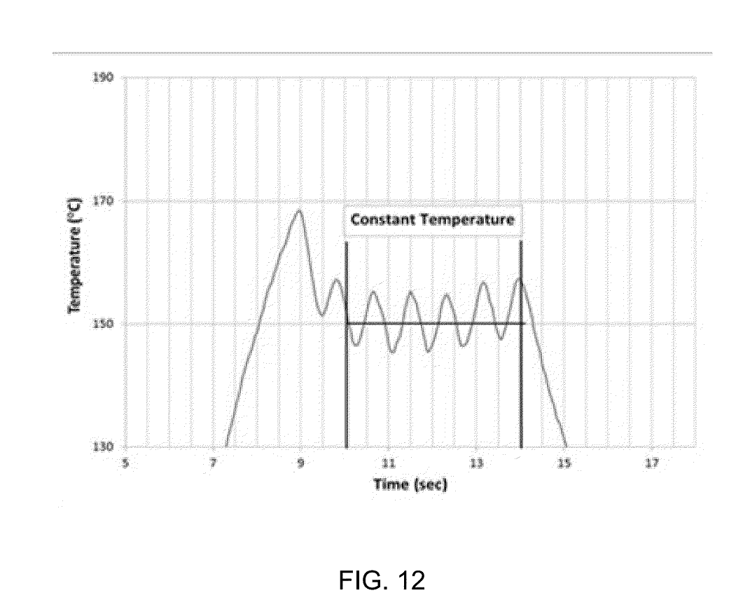

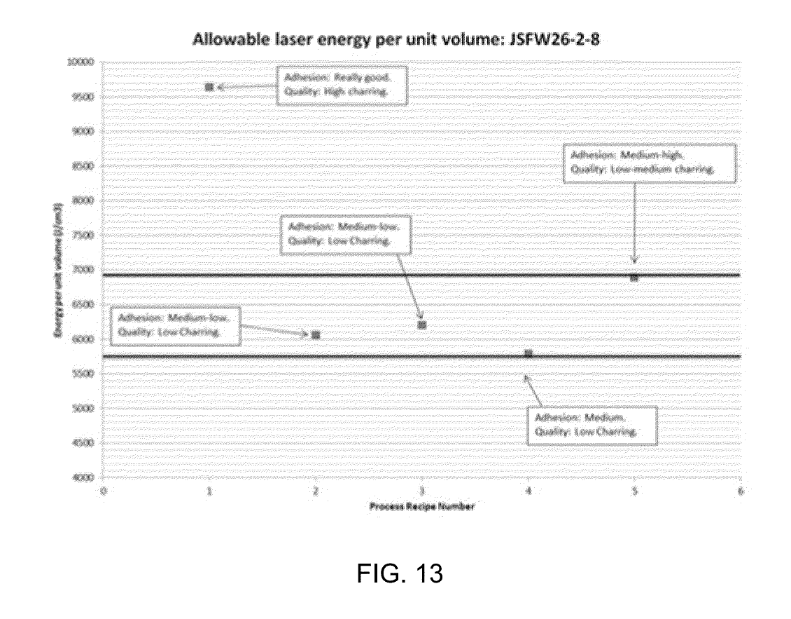

The particular heating profile, particularly the temperatures and power ramps, to be employed during automatic operation of the tool will depend, at least in part, upon the size of the TPU fastener being used. The following discussion describes a process that was employed to determine an optimum laser melt recipe for a particular TPU dot size; in this case the TPU dot was a specific for use with a 6.4 mm fastener head diameter. This process can be repeated for each size of TPU dot to be applied. Development of an optimized installation process for each TPU dot size/type involves several determinations, such as finding an upper and lower working range for the TPU dot (FIG. 10), finding an upper and lower range of energy per unit volume for the TPU dot (FIG. 13), finding power cycling method to keep temperature constant (FIG. 12) and determining the maximum power ramp for the heating process (FIG. 11). Preferably the melting process can be completed within a time frame of 15 seconds.

### Experimental Set-Up

The NIR laser set-up was automated through a computer program for recipe input. The laser collimator was attached to an 8× variable zoom beam expander, which was able to adjust the beam size from 5 mm (1×) to 40 mm (8×) in diameter. The beam size of this set-up is manually adjustable for various TPU dot sizes by turning a dial. For a specific size TPU dot optimization, the beam size was set to 2.5× (12.5 mm in diameter). The collimator and beam expander assembly were housed in a laser gun assembly. The laser gun assembly was mounted perpendicular to a breadboard on a test stand for ease of use. This allowed laser energy to directly target TPU dot in a vertical direction. The TPU dot was pressed against a 12 mm fastener under a 4 mm thick fluoropolymer. The fastener was drilled through from top to bottom for thermocouple insertion. The temperature data was collected via a thermocouple inserted towards the top surface of the drilled hole; the temperature of the bottom of the TPU dot was recorded in real time for each process run. The guide beam on the laser was used to align the TPU dot with the fastener head during tests.

Several TPU dots were exposed with a two-step laser power program for 12 seconds to determine upper and lower range of temperature to achieve optimal melt quality. FIG. 10 shows a graph of temperature vs. time for nine different experimental samples exposed with a two-step laser power program. It was observed that when the thermocouple temperature exceeded 177° C. (351° F.), TPU dot degradation (charring) occurred around the center. It was also noticed that when TPU dot temperature was below 154° C. (309° F.), adhesion with the fastener surface was quite weak. The working temperature of 154° C. to 177° C. (309° F. to 351° F.) was considered ideal for this dot size.

### Optimal Power Ramp Rate:

To minimize total process time of the recipe, it is desirable to reach the melting temperature quickly. Optimization of the initial power ramp rate was achieved by varying the initial power and observing corresponding TPU dot melt quality. FIG. 11 shows a graph of temperature vs. time at different laser ramp rates. A faster increase in power above its optimal ramp rate charred the top surface of the TPU dot and a slower increase in power took longer than desired time. A fine balance was achieved by varying the power ramp at various levels and observing the TPU dot surface quality. The surface quality was characterized by highly charred, medium charred and low charred surfaces. The ramp levels were set at 80 W/s, 60 W/s, 50 W/s and 25 W/s (FIG. 11).

At 80 W/s ramp, 30 percent of the dot surface was charred around the center indicating very fast ramp rate. Some TPU material from the contact area formed a bond with the fluoropolymer and peeled off when lifted. At 60 W/s, TPU dot surface also charred around the center with approximately 15 percent of the TPU dot surface. At 50 W/s charring was very light and only accounted for less than 5 percent of the area in the center of the surface, indicating almost optimal ramp rate. At 35 W/s there was no charring observed. From this observation, it was determined that power ramp rate should be kept just less than 50 W/s for optimized dot quality.

In order to ensure a thorough dot melt with good adhesion, a pulsed power step was used in the recipe. This was achieved by inserting power on and off cycles for 0.5 seconds on, and 0.5 seconds off. FIG. 12 shows a graph of temperature vs. time using a determined optimal power cycle for the laser. Varying total times of pulsing were used from 3 to 6 seconds total. The pulse power was set at the final stage power level. This is to hold the dot temperature in the optimal melting range, without causing charring. The primary purpose of constant temperature in the recipe development was to ensure excellent adhesion to the fastener surface.

TPU dot melt temperature and initial power ramp are significant factors for the optimal process design. However, applied energy per unit volume of the recipe can also provide useful information. The relationship between TPU material quality (charring) and fastener surface adhesion are inversely related and an ideal process requires both of them to be of superior quality. A balance of these two factors can be achieved by observing energy per unit volume. It is anticipated that laser energy per unit volume of the TPU material would stay within a constant range across various dot sizes providing a benchmark for process optimization. During this time period, Applicants plotted a range of energy per unit volume for 12 mm diameter TPU material below which material could not melt properly and above which material overheated by showing surface degradation.

As shown in FIG. 13, various process recipes were plotted with their respective energy per unit volume and performance. When the energy applied on the dot was 9600 J/cm3, the charring of the material observed was quite high but the adhesion to the fastener surface was also strong. For the recipe with 6900 J/cm3, adhesion was medium-high and charring was low-medium. For energy values between 5800-6200 J/cm3, charring was really low but adhesion was also on the low-medium range. From this analysis, it was determined that the ideal range of energy for a process recipe should be between 5800-6900 J/cm3.

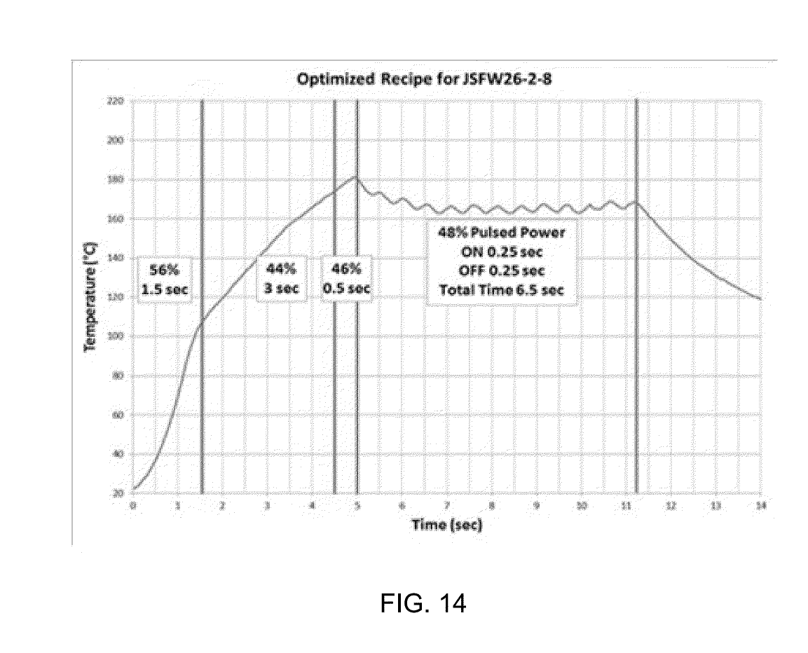

After finding the upper and lower temperature, power ramp rate and energy per unit volume for 12 mm diameter TPU dot, an optimized process recipe was developed. FIG. 14 a graph of temperature vs. time for the optimized process recipe. As shown in FIG. 14, the optimized recipe had four different steps: step 1—56 percent power for 1.5 seconds, step 2—44 percent power for 3 seconds, step 3—46 percent power for 0.5 seconds and step 4—48 percent pulsed power. With this process, the melt quality and surface adhesion were very good.

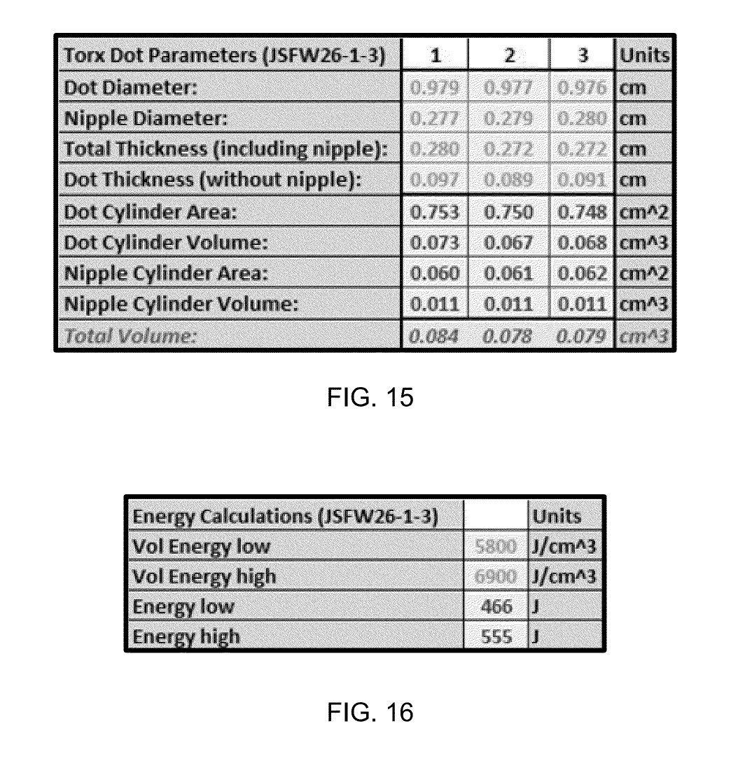

Using the energy per unit volume range established during the laser melt optimization task, laser melt recipes can be easily generated for new dot sizes. The process recipe can be developed by physically measuring each dot and calculating the optimal range of energy required for the laser melt recipe. As an example, the TPU dot with 9.75 mm diameter recipe calculation and optimization is demonstrated in FIGS. 15 and 16. This calculation for a process energy range is to be used as a guide with laser melt trials to determine the optimal recipe that has good melt and strong adhesion without charring in a short time frame.

Using digital calipers, the dimensions of three dots were measured, and the total volume of the TPU material was calculated. Once the volume is known and using the energy range of 5800 to 6900 J/cm3, the lower and upper energy limit total for the laser melt process recipe can be calculated. The lower and upper limits of the calculated energy spectrum correspond with adhesion and melt characteristics. The lower energy limit may melt the dot with medium adhesion, and the upper energy limit may melt (or possibly char) the dot with a high level of adhesion.

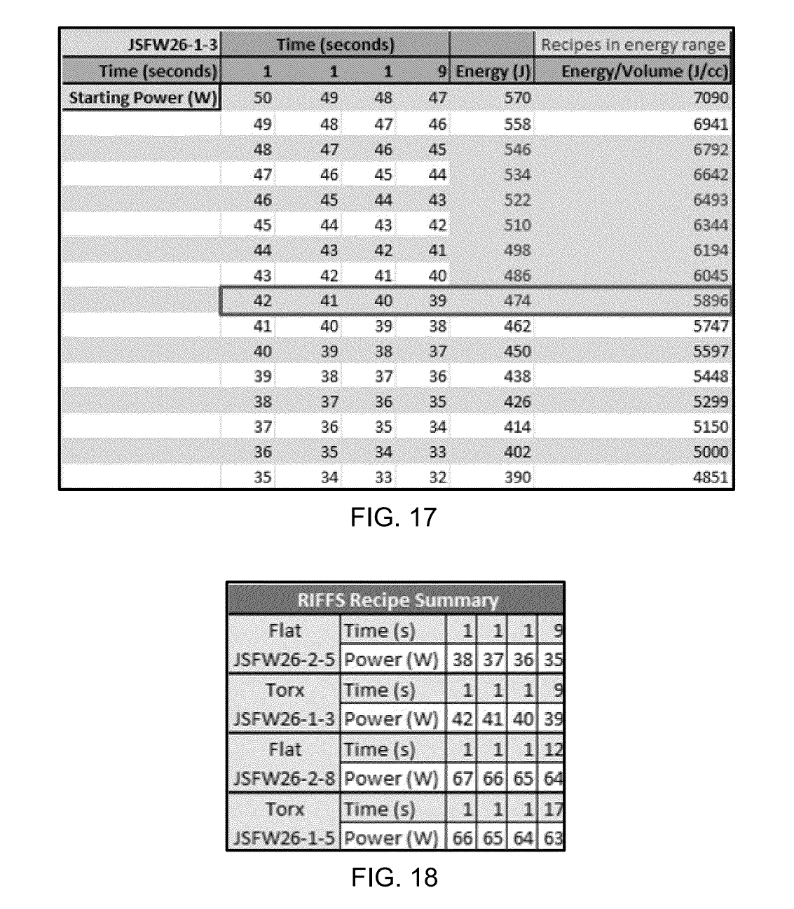

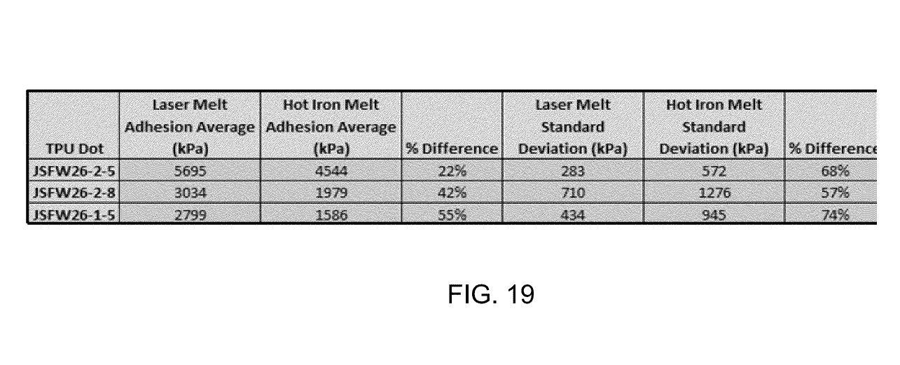

From previous trials, it has been determined that an initial fast power ramp improves adhesion, and allows for short process recipe time. Therefore, Applicants developed process recipes with the highest power first, then decreasing in power for a few seconds, and finally holding the power level constant for the remainder of the recipe. The process recipe is developed by entering an initial power level and a total desired time frame. After adjusting these parameters and determining several recipes that fit the total energy process window, the recipes were then used to install the targeted dot with the installation tool to determine the best adhesion without charring in a short time frame (ideally less than 20 seconds). FIG. 17 is a table showing calculated total energy values for the optimal process recipe for a given TPU dot type calculated from a decreasing gradient of power and a total time desired.

Using this methodology, optimized laser melt recipes were determined for the 7.9 mm, 12 mm, 16.1 mm (torx) and 9.75 mm (torx) diameter TPU dots. A summary of the recipes is shown in FIG. 18. For smaller diameter dot sizes, the total recipe time was 12 seconds. For the larger diameter dot sizes, the total time was 15 seconds and 20 seconds.

In addition to installation recipes, Applicants also developed removal recipes for the smaller dot sizes 7.89 mm diameter and 9.75 mm diameter. The dot removal recipe for each dot size is determined by setting the laser power level for a specified amount of time such that the upper limit of energy per unit volume (6900 J/cm3) is exceeded. In the case of 9.75 mm diameter dot, the removal recipe was 50 watts power for 12 seconds. The total energy of this recipe (600 J) exceeds the upper limit of energy (555 J).

It should be noted that beam size should also be taken into consideration for recipe development. If the beam area desired is greater than the dot surface area (by approximately more than 20 percent), energy loss outside of the dot area should be accounted for. In the case of 9.75 mm diameter dot, the beam diameter used was 11.7 mm, and the dot diameter was 9.75 mm. Applicants conducted a number of tests to measure the power output level of the laser at different beam diameter settings, and took these measurements into consideration when developing new recipes. Each system can perform differently based on specific system components such as the beam expander. The energy per unit volume requirement for each TPU dot melt recipe is used as a simple guide for recipe optimization. TPU dot melt trials are always required to optimize each recipe with an appropriate beam size, but following this straightforward method allows for ease of recipe optimization by a process engineer.

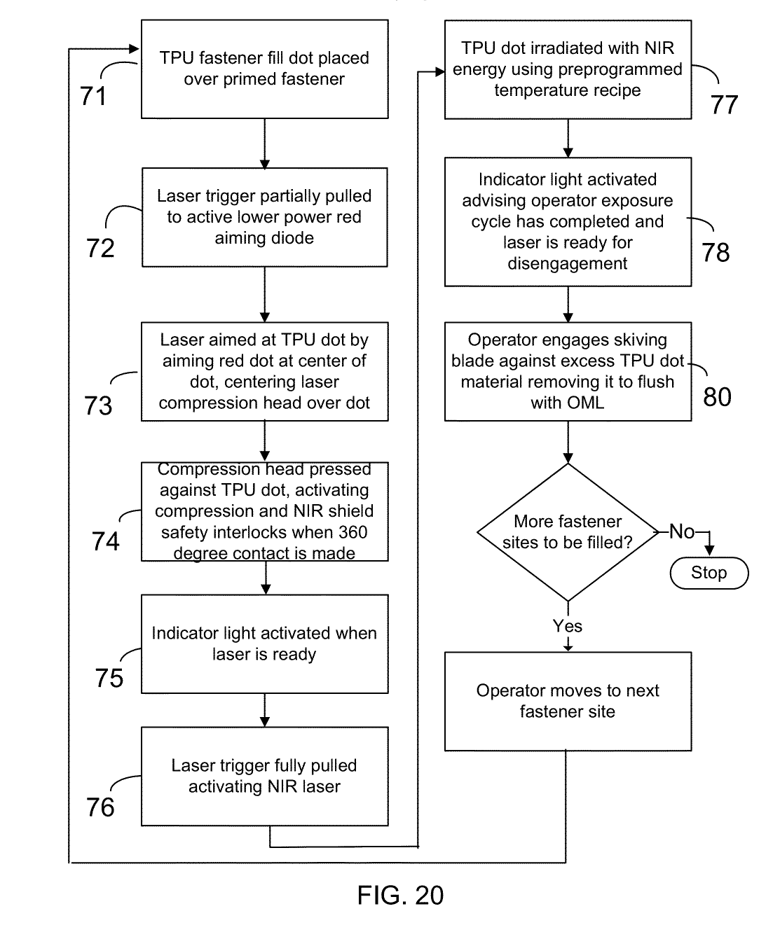

FIG. 20 is a flow chart showing the steps in operating a filler installation tool according to embodiments of the present invention. In Step 71, a TPU fastener fill dot is placed over a primed fastener. In step 72, the operator partially pulls the laser trigger to activate the low power, red aiming diode. In Step 73, operator aims red aiming diode at center of TPU dot, centering laser compression head over dot. TPU dot is engaged by pressing compression head against center of TPU dot, activating safety interlocks built into the compression head and the NIR shield, which are activated when 11.3 kg (25 lb) pressure is applied. In step 75, a light on the tool indicates to the operator that the laser is ready to activate. In step 76, the operator fully pulls the laser trigger to active the NIR laser. In step 77, the underlying TPU dot is irradiated with NIR energy using a preprogrammed recipe that automatically varies the power levels and exposure times. In step 78, a light on the tool indicates to the user that the laser has completed its exposure cycle and is ready to be disengaged from the installed TPU dot. If at any time the safety interlocks are disengaged during the exposure, the laser emission immediately deactivates and an error indicator is shown on the tool.

In step 79, the operator picks up skiving system. In step 80, the operator engages the skiving blade against the excess TPU dot material and removes excess prominent fastener fill material to flush with the aircraft OML. In step 81, the operator repeats this process at the next fastener site.

The invention has broad applicability and can provide many benefits as described and shown in the examples above. The embodiments will vary greatly depending upon the specific application, and not every embodiment will provide all of the benefits and meet all of the objectives that are achievable by the invention. Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention. After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive- or and not to an exclusive- or. For example, a condition A or B is satisfied by any one of the following: A is true (or present) and B is false (or not present), A is false (or not present) and B is true (or present), and both A and B are true (or present). Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

Although the present invention and its advantages have been described in detail, it should be understood that various changes, substitutions and alterations can be made to the embodiments described herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1-42. (canceled)

43. A method for rapidly adhering filled polymer material over a metallic surface, the method comprising:
(a) placing a solid volume of a polymer material over metallic surface;
(b) directing a laser toward said polymer material;
(c) applying pressure on the polymer material; and
(d) irradiating said polymer material until the polymer material melts and adheres to the metallic surface.

44. The method of claim 43 in which the metallic surface comprises an installed fastener head.

45. The method of claim 43 in which step (d) is accomplished automatically at a volumetric melt and adhesion rate of 3.1 mm3/s to 11.8 mm3/s for a polymer material thickness of less than or equal to 5 mm.

46. The method claim 43 in which directing a laser toward said polymer material comprises directing a laser toward said polymer material using a near-infrared radiation laser tool comprising:
a laser optics and fiber;
a housing for holding said laser optics and fiber and maintaining a desired distance and orientation of the laser relative to the fastener to be filled;
electronics for controlling said laser;
a collimator;
a beam expander; and
a laser shield.

47. The method of claim 46 in which the near-infrared radiation laser tool further comprises a conformal dome for holding the polymer material in place and applying pressure to the polymer material during melting.

48. The method of claim 46 in which the near-infrared radiation laser tool further comprises a flat pressure head for holding the polymer material in place and applying pressure to the polymer material during melting.

49. The method of claim 43 in which irradiating said polymer material until the polymer material melts and adheres to the metallic surface comprises irradiating said polymer material to heat the polymer material to a temperature above the melting point and/or below the charring point of the polymer material.

50. The method of claim 43 in which the laser has a wavelength of 750 to 2500 nm.

51. The method of claim 43 in which the solid volume of a polymer material comprises polymer material dots attached to a near-infrared radiation laser opaque Teflon stripe.

52. The method of claim 43 in which directing a laser toward said polymer material comprises directing a laser toward said polymer material using a pulsed power step during which the laser is cycled between powered on and powered off.

53. The method of claim 43 in which irradiating said polymer material comprises irradiating said polymer material so that the laser energy per unit volume for the polymer material is maintained in a range between a minimum (Evₘᵢₙ) and maximum (Evₘₐₓ) and in which the laser energy is applied to the polymer material in i number of stages, where i=1, 2, 3 . . . n. comprising the following steps in sequence:
(a) Stage 1 in which the laser energy is applied to the polymer material for j seconds, where j=1, 2, 3 . . . n, in which the laser power is ramped up at a rate below visibly observable polymer charring until a maximum power output is reached;
(b) Stage 2 in which the laser energy is applied to the polymer material for k seconds, where k=1, 2, 3 . . . n, at a lower power than the maximum power output from Stage 1;
(c) Stage 3 in which the laser energy is applied to the polymer material for 1 seconds, where 1=1, 2, 3 . . . n, at a lower power than the power used in Stage 2; and
(d) Stage n in which the laser energy is applied to the polymer material for m seconds, where m=1, 2, 3 . . . n, and the laser energy applied during State n is between E=Evₘₐₓ−(E_{stage1}+E_{stage2}+E_{stage3}+ . . . E_{stage-n}) and E=Evₘᵢₙ−(E_{stage1}+E_{stage2}+E_{stage3}+ . . . +E_{stage-n}).

54. The method of claim 43 further comprising positioning polymer material beneath a conformal dome or compression head such that laser energy cannot escape into areas around TPU material.

55. The method of claim 43 in which the polymer material comprises thermoplastic polyurethane (TPU).

56. The method of claim 55 in which directing a laser toward said TPU comprises ramping up the laser power per area at a rate of 10 W/s to 50 W/s.

57. A laser apparatus for rapid fastener fill comprising:
laser optics including a fiber-optical cable for producing a laser beam;
a housing for holding said laser optics and fiber-optical cable;
electronics for controlling said laser;
a collimator;
a beam expander;
a laser shield; and
a conformal dome and/or a flat pressure head for holding a volume of a solid polymer material in place for applying pressure during melting.

58. The apparatus of claim 57 comprising a conformal dome for holding the volume of a solid polymer material in place and in which the conformal dome is comprised of Fluoropolymer between 1 mm and 30 mm thickness.

59. The apparatus of claim 57 comprising a flat pressure head in which the flat pressure head has a window comprised of laser transparent quartz or glass.

60. The apparatus of claim 57 in which the laser will only activate when (1) a toggle switch on the apparatus is turned on; (2) a preselected minimum force is applied by the flat pressure head or conformal dome; and (3) a trigger on the apparatus is pressed by the user.

61. The apparatus of claim 57 in which the laser shield is comprised of material that is transparent to visible light but opaque to the wavelength of the laser.

62. The apparatus of claim 57 in which the laser comprises a near-infrared radiation laser.
